(19) United States
(12) Patent Application Publication
(10) Pub. No.: US 2005/0247545 A1
(43) Pub. Date: Nov. 10, 2005

(54) Conveyor having electrostatic discharge protection structure

(75) Inventors: Hou-Yao Ni, Hsinchu City (TW); Kuang-Chen Yeh, Chiayi City (TW); Jung-Huang Chien, Hsinchu City (TW); Chin-Yuan Lin, Jhunan Township (TW); Hung-Te Lai, Taichung City (TW)

Correspondence Address: LIU & LIU, 444 S. FLOWER STREET, SUITE 1750, LOS ANGELES, CA, 90071, US

(73) Assignee: Toppoly Optoelectronics Corp.

(21) Appl. No.: 11/056,434

(22) Filed: Feb. 10, 2005

(30) Foreign Application Priority Data
May 6, 2004 (TW) 93112728

(51) Int. Cl. B65G 13/02

(52) U.S. Cl. 198/780

(57) ABSTRACT

An ESD protection structure, comprising at least one conductive roller. The conductive roller comprises a conductive roller body, and a supporter supporting the conductive roller. The supporter is grounded.

### BACKGROUND

The present invention relates to an ESD (Electrostatic Discharge) protection structure and more particularly, to an ESD structure used in a conveyor of a LCD manufactory.

In current manufacturing processes for flat displays, rollers are disposed in a conveyor to convey unmanufactured substrates. A rubber layer or a plastic layer is generally formed to cover the surface of the roller, serving as a buffer layer to release collision therebetween during conveyance and to prevent the conveyed substrates from scratch. Furthermore, a rubber or plastic layer can provide considerable friction force, making the conveyance smooth. Nevertheless, rubber or plastic is unable to withstand high temperatures and therefore cannot be used for high temperature process. Thus a roller made of or covered by thermal resist material is generally used in areas where the processing temperature exceeds the temperature which rubber or plastic cannot withstand.

The thermal resist material is, for example, quartz. Generally, substrates of flat displays are glass. Quartz roller and glass are both electrical isolation material, and during conveyance, this combination easily accumulates mass static electricity due to the friction generated between quartz and glass. Electrostatic discharge device such as ionizers or soft x-rays also cannot be used to neutralize the accumulated charge under high working temperatures such as over 600° c. The accumulated mass static electricity has no way to disperse thus product damage may result.

In the manufacturing process for low temperature poly silicon liquid crystal display for example, a rapid thermal annealing process (RTP) is a typically employed. A typical annealing process apparatus is shown in FIG. 1. The annealing process apparatus comprises a pre-heat zone 10 comprising infrared halogen lamps for heating the glass substrate from room temperature to a setting temperature. A thermal process zone 20 comprising a xenon arc lamp to heat the silicon film layer from pre-heat temperature to another setting temperature. A post process heating zone 30 comprises infrared halogen lamps for slowly cooling the glass substrate from a high temperature to a low temperature to prevent malfunctions caused by rapid cooling. A conveyor system 50 includes a motor to drive the belt driving the quartz roller for transferring the glass substrate 42 passing through the high temperature area. FIG. 2 shows a top view of the RTP chamber 1. The roller 40 is mounted between two side chamber walls 41. A glass substrate 42 is placed on the roller 40 and transferred in the direction indicated by the arrows.

FIG. 3 shows a structural diagram of a traditional roller 40. The roller 40 comprises a quartz roller body 400 and two stainless adapters 402. As described above, the quartz roller body 400 and the glass substrate 42 are both insulation materials. During conveyance, mass static electricity is accumulates due to the friction generated between the quartz roller body 400 and the glass substrate 42. The accumulated mass static electricity has no way to disperse thus glass substrate 42 damage may occur. Damage may comprise scorched tips or conducting line, resulting in electrical leakage.

### SUMMARY

An embodiment of the invention provides a conductive roller with a conductive roller body, and a supporter supporting the conductive roller body. The supporter is electrically conductive and is grounded.

An embodiment of the invention also provides an annealing apparatus, for performing a heating process on at least one glass substrate. The annealing apparatus has a plurality of rollers, among which one is electrically conductive. The conductive roller comprises a conductive roller body and a supporter supporting the conductive roller body. The supporter is electrically conductive and is grounded.

A detailed description is given in the following with reference to the accompanying drawings.

### BRIEF DESCRIPTION OF THE DRAWINGS

Embodiments of the present invention can be more fully understood by reading the subsequent detailed description and examples with references made to the accompanying drawings, wherein:

FIG. 1 is a main structure diagram of a typical LTP annealing apparatus;

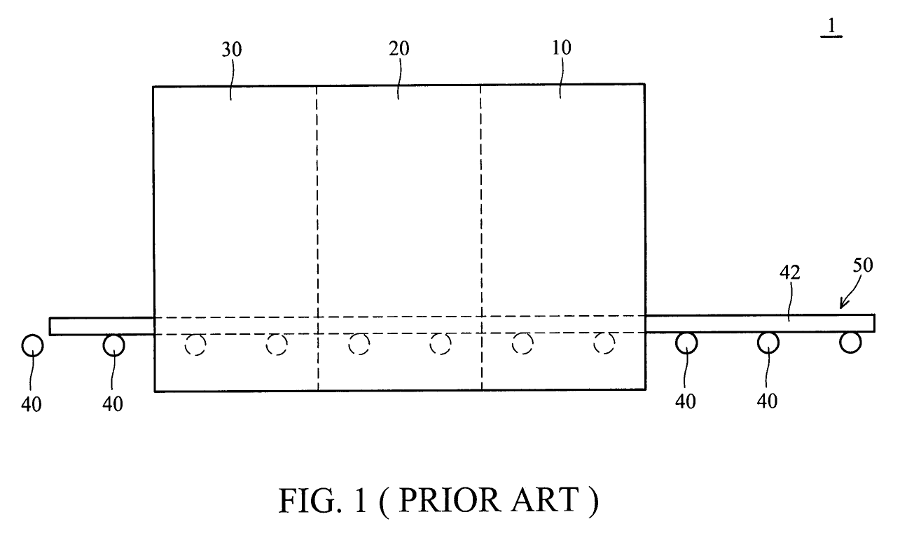

FIG. 2 is a top view diagram of a RTP chamber;

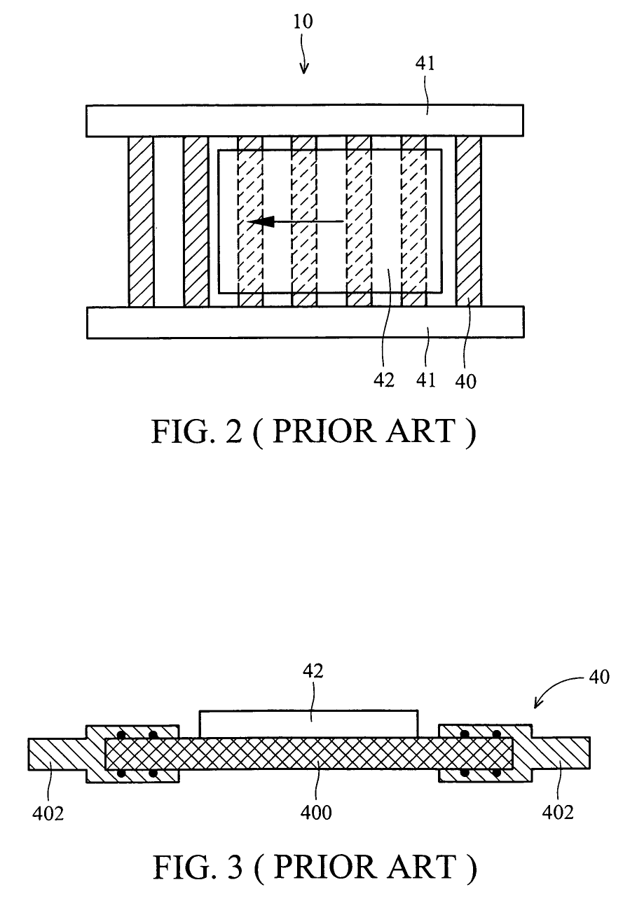

FIG. 3 is a structure diagram of a typical roller;

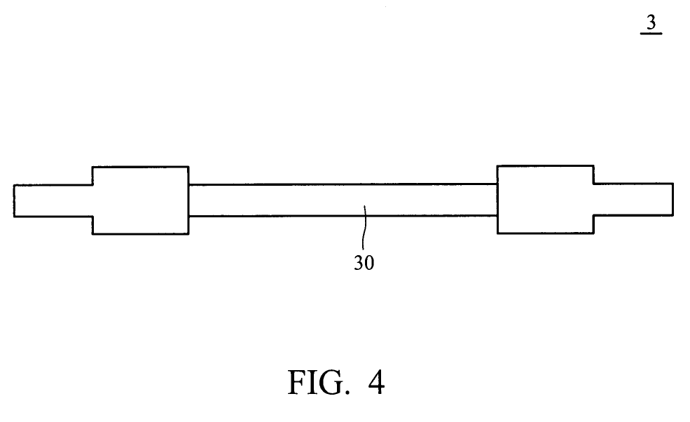

FIG. 4 is a plan diagram of a roller in accordance with an embodiment of the invention;

FIG. 5 is a plan diagram in accordance with a first embodiment of the invention;

FIG. 6 is a plan diagram in accordance with a second embodiment of the invention;

FIG. 7 is a diagram showing installation of an ESD protection device in a RTP annealing apparatus;

FIG. 8A and FIG. 8B is diagram of an experimental result.

### DETAILED DESCRIPTION

### First Embodiment

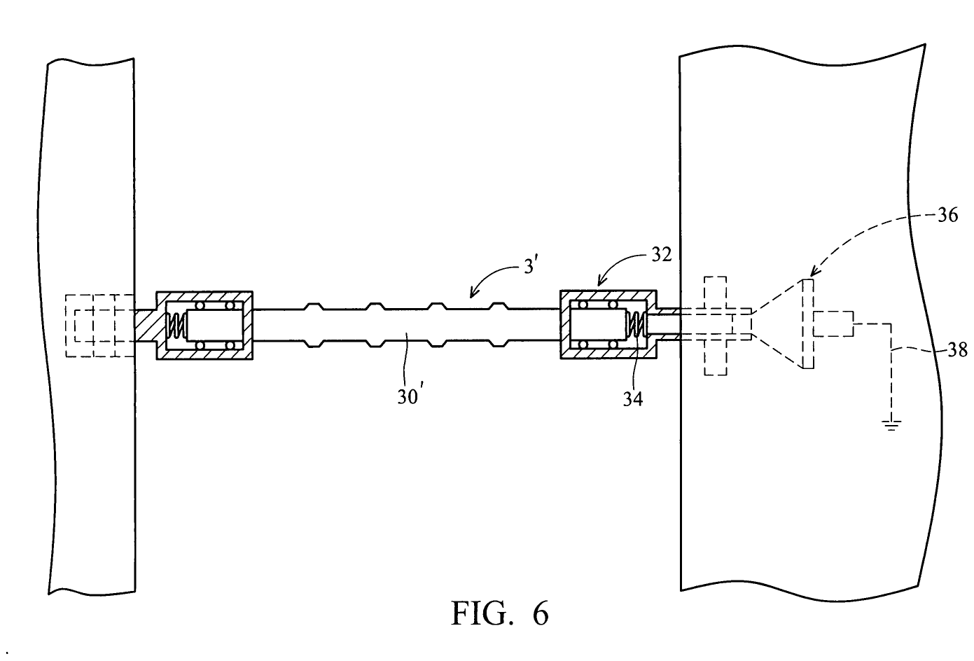

FIG. 5 is a structural diagram according to a first embodiment of the invention. The roller 3 is capable of being mounted on a conveyer of an apparatus, such as an annealing apparatus. The roller 3 comprises an electrically conductive roller body 30.

The conductive roller body 30 comprises refractory material such as stainless steel or silicon carbide. The silicon carbide, which is adapted to RTP chamber of annealing apparatus, can withstand high temperature. Other refractory material such as silicon molybdenum, graphite, and metal carbides, capable of enduring temperatures exceeding approximate 600° C. can also be employed.

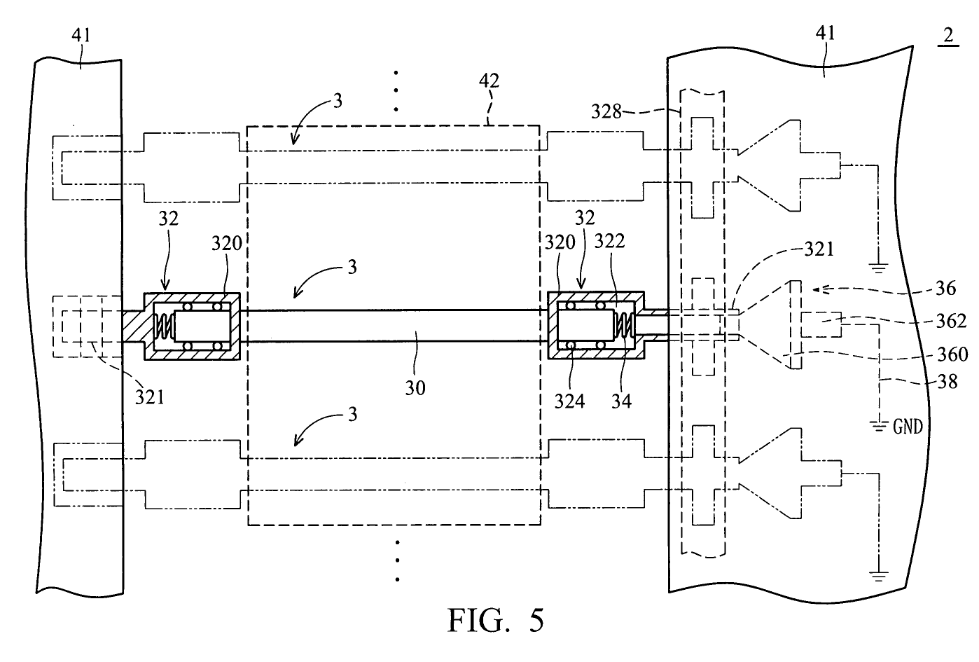

When a glass substrate 42 (not shown in FIG. 4; shown in FIG. 5) is transferred by the conductive roller 3, the static electricity generated between the glass substrate and the electrically conductive roller body 30 is dispersed throughout the conductive roller body 30. The static electricity generated by the glass substrate and the roller 3 are thus reduced. Damage and dust, two possible results of the static electricity, are accordingly reduced, thereby improving product yield.

FIG. 5 is an ESD protection device according to the first embodiment of the invention, adapted to a conveyor of an apparatus operating at relatively high working temperature areas, such as low temperature polysilicon liquid crystal annealing apparatus for example. The ESD protection device 2 comprises a plurality of conductive rollers 3 to load at least one glass substrates 42. The roller 3 comprises a conductive roller body 30, conductive supporters 32, conductive elastic elements 34 and conductive rotary connector 36.

The conductive roller body 30 can be stainless steel or silicon carbide. Silicon carbide, a kind of refractory material, can endure high temperature and is adapted to the RTP chamber of an annealing apparatus. Other refractory material such as silicon molybdenum, graphite, and metal carbides, capable of enduring temperatures exceeding approximate 600° C. can also be employed. The stainless steel roller, nevertheless, cannot endure high temperatures, and thus is typically only used in a conveyor area where the temperature is relatively lower.

Two conductive supports 32 are respectively mounted at two ends of the conductive roller body 30. Each conductive support 32 has an adapter 320 comprising a sleeve disposed at one end of the conductive roller body 30. Two O rings 324 are disposed between each adapter 320 and conductive roller body 30 for fixing the conductive roller body 30. A space 322 is formed between an end of the conductive roller 30 and a bottom surface of the adapter 320. An elastic element 34 such as metal spring is disposed therein. The elastic element 34 can be a metal spring or other metal elastic element, electrically connecting conductive roller 30 and adapter 320.

A conductive rotary connector 36, such as a mercury connector, comprises a conductive rotary body 360 and a conductive connecting element 362 connected to the rotary body 360. The rotary body 360 is connected to the end 321 of the support 32 and can relatively rotate on the connecting element 362. The connecting element 362 is then electrically coupled to the a ground through a conductive line 38. A belt 328 physically links conductive rotary connectors 36 to make them roll or rotate simultaneously.

Thus, a conductive path is formed by the conductive roller body 30, conductive elastic element 34, mercury connector 36, and conductive line 38. When static electricity is generated by roller 3 and glass substrate 42, static electricity disperses through the conductive path to the ground GND, thereby preventing ESD damage.

### Second Embodiment

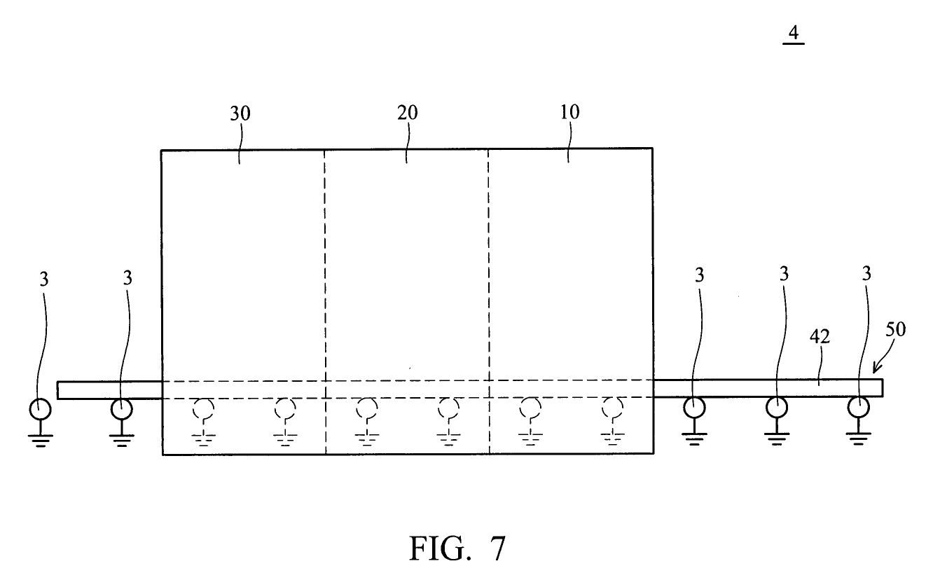

FIG. 6 shows a second embodiment of the invention. The structure of the conductive roller 3′, the conductive supporter 32, conductive elastic element 34, and conductive rotary connectors 36 are substantially the same as is FIG. 5. The main difference is that the shape of the conductive roller body 30′ is jagged or uneven, thus the contact area between the roller body 30′ and the substrate thereon is reduced, thereby reducing the dust and static electricity generated by friction.

Deployment in a RTP Annealing Apparatus

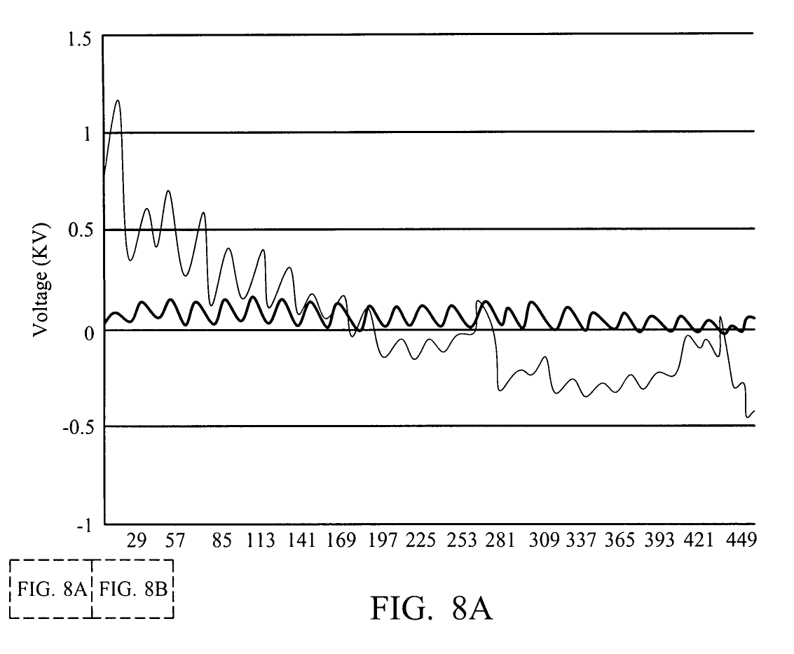

In reference to FIGS. 7 and 5, rollers 3, each acting as an ESD protection device, are disposed in a RTP-annealing apparatus 4. Each roller 3 is disposed between two chamber side walls 41.

The roller 3 is driven by a belt 328 driven by a motor (not shown) of a conveyer 50 for conveying the substrates 42 through pre-heat area 10, thermal process 20 and post process heating zone 30. Whenever static electricity generated by a roller 3 and the glass substrate 42, this static electricity can be easily conducted through the roller 3, conductive elastic element 34, conductive support 32, conductive rotary connector 36, conductive line 38, to ground GND, thereby preventing ESD damage.

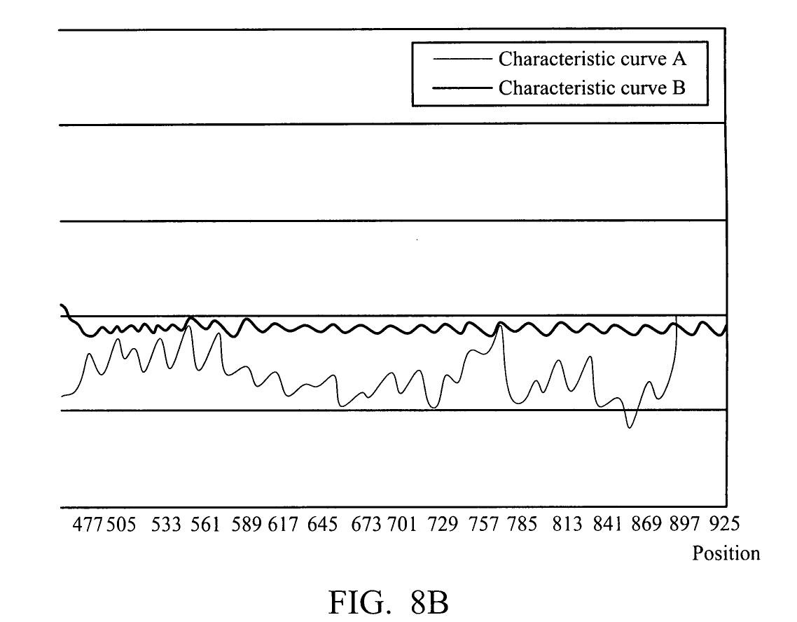

FIG. 8A and FIG. 8B show a diagram of simulation curve, where the horizontal axis represents the location along the conveyor within a chamber, and the vertical axis measured ESD voltage. Characteristic curve A shows the experiment results by using a traditional quartz roller, while characteristic curve B shows the measured results by using the conductive roller according to one embodiment of the invention. It is observed that high ESD voltage occurs at the beginning of the horizontal axis even low ESD voltage can be found somewhere else. It implies that ESD charges are easily accumulated at the near end, risking ESD damage there. From the result of the experiment, by using the conductive roller, the ESD protection device of the invention provides uniform ESD voltage in comparison with what the conventional ESD devices provides, thus improving ESD protection.

While the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation to encompass all such modifications and similar arrangements.

1. A ESD discharge protection structure, comprising:
an electrically conductive roller body; and
a support, supporting the conductive roller body, wherein the support is electrically conductive and electrically grounded.

2. The ESD discharge protection structure as claimed in claim 1, wherein the supporter is a stainless steel support.

3. The ESD discharge protection structure as claimed in claim 1, wherein the conductive support further comprises a conductive rotary connector, wherein the conductive rotary connector includes a rotary body and a connecting element connected to the rotary body, the rotary body is mounted at one end of the supporter and is rotatable on the connecting element, and the connecting element is electrically grounded.

4. The ESD discharge protection structure as claimed in claim 3, wherein the conductive rotary connector is a mercury connector.

5. The ESD discharge protection structure as claimed in claim 1, wherein the conductive roller body material comprises silicon carbide, silicon molybdenum, graphite, metal carbides, stainless steel or combinations thereof.

6. The ESD discharge protection structure as claimed in claim 1, wherein the supporter comprises an adapter, disposed at one end of the conductive roller body, forming a space between the end of the conductive roller body and a bottom of the adapter.

7. The ESD discharge protection structure as claimed in claim 6, further comprising a conductive elastic member disposed in the space, and the two ends of the conductive elastic member respectively contact to the conductive roller body and the adapter.

8. The ESD discharging protection structure as claimed in claim 7, wherein the conductive elastic member is a metal spring.

9. The ESD discharging protection device as claimed in claim 1, wherein the shape of the electrically conductive roller body is jagged or uneven.

10. An apparatus, for operating a heating process to at least one substrate, wherein the apparatus comprises the ESD discharging protection structure as claimed in claim 1.

11. A method of abating ESD in a conveying system, comprising:
providing an electrically conductive roller;
supporting the electrically conductive roller with supports, wherein at least one support is electrically conductive; and
grounding said conductive support.
